(19) United States
(12) Patent Application Publication
(10) Pub. No.: US 2010/0299682 A1
(43) Pub. Date: Nov. 25, 2010

(54) METHOD AND APPARATUS FOR EXECUTING JAVA APPLICATION

(75) Inventor: Ho-bum KWON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/751,389

(22) Filed: Mar. 31, 2010

(30) Foreign Application Priority Data
May 21, 2009 (KR) 10-2009-0044495

(51) Int. Cl. G06F 9/52

(52) U.S. Cl. 719/328

(57) ABSTRACT

A method and apparatus for executing a Java application are provided. The method includes calling, by a first thread, an application programming interface (API) required to execute the Java application, determining whether the API is a first synchronization API which uses processing results of at least one previously called API, and if it is determined that the API is the first synchronization API, executing the first synchronization API through a second thread different from the first thread calling the first synchronization API.

### CROSS-REFERENCE TO RELATED PATENT APPLICATION

This application claims priority from Korean Patent Application No. 10-2009-0044495, filed on May 21, 2009, in the Korean Intellectual Property Office, the disclosure of which is incorporated herein in its entirety by reference.

### BACKGROUND OF THE INVENTION

1. Field of the Invention

Methods and apparatuses consistent with the present invention relate to executing an application, and more particularly, to executing a Java application.

2. Description of the Related Art

Java is a programming language which is selected as a standard platform in a variety of next-generation industries. For example, Java is commonly used in digital broadcasting applications and Blu-ray disk applications. Java usage has increased due to improved application execution speed.

A graphic user interface (GUI) has been increasingly used as an application interface. Thus, most applications are designed to be executed based on a GUI, and a Java application written in Java is, preferably, designed to be executed based on a GUI.

### SUMMARY OF THE INVENTION

Exemplary embodiments of the present invention provide a method and apparatus for effectively executing a Java application.

According to an aspect of the present invention, there is provided a method of executing a Java application, the method including calling, by a first thread, an application programming interface (API) required to execute the Java application; determining whether the API is a first synchronization API which uses processing results of at least one previously called API; and if it is determined that the API is the first synchronization API, executing the first synchronization API through a second thread different from the first thread calling the first synchronization API.

The executing of the first synchronization API may include determining whether processing of a second synchronization API called before the first synchronization API is completed; and if it is determined that the processing of the second synchronization API is not completed, controlling the first synchronization API to delay the executing of the first synchronization API.

The method may further include processing at least one other API called after the first synchronization API through the first thread.

The executing of the first synchronization API may further include, if it is determined that the processing of the second synchronization API is completed, receiving a confirmation signal from the second thread indicating that the processing of the second synchronization API is completed.

The executing of the first synchronization API may further include, if it is determined that the processing of the second synchronization API is completed, receiving a confirmation signal, from a hardware-based module, indicating that the processing of the second synchronization API is completed.

At least one of the first synchronization API and the second synchronization API may be an output API which outputs an image to an output device.

The output API may be a ‘sync( )’ API defined in a Java standard library. In detail, the output API may be a ‘java.awt.Toolkit’ synchronization API defined in a ‘Personal Basis Profile’ of a lower layer.

The controlling the first synchronization API to delay the executing of the first synchronization API may be performed by the first thread.

The first synchronization API may use processing results of the second synchronization API.

According to another aspect of the present invention, there is provided an apparatus for executing a Java application, the apparatus including a calling unit which includes a first thread which calls an API required to execute the Java application; a determination unit which determines whether the API is a first synchronization API which uses processing results of at least one previously called API; and a processing unit which executes the first synchronization API through a second thread different from the first thread which calls the first synchronization API, if the determination unit determines that the API is the first synchronization API.

### BRIEF DESCRIPTION OF THE DRAWINGS

The above and other aspects of the present invention will become more apparent by describing in detail exemplary embodiments thereof with reference to the attached drawings in which:

FIGS. 1A, 1B and 1C are layer diagrams of a Java platform, according to an exemplary embodiment;

FIG. 2 is a diagram of an application embodying a graphic user interface (GUI), according to an exemplary embodiment;

FIG. 3 is a block diagram of a Java application executing apparatus according to an exemplary embodiment of the invention;

FIG. 4 is a diagram showing a method of executing a Java application in the Java application executing apparatus of FIG. 3, according to an exemplary embodiment;

FIG. 5 is a flow chart of a method of executing a Java application, according to an exemplary embodiment;

FIGS. 6A and 6B are diagrams showing operations of embodying a GUI using a Java application; and

FIG. 7 is a flowchart of a method of executing a Java application, according to another exemplary embodiment.

### DETAILED DESCRIPTION OF THE INVENTION

Exemplary embodiments will now be described more fully with reference to the accompanying drawings.

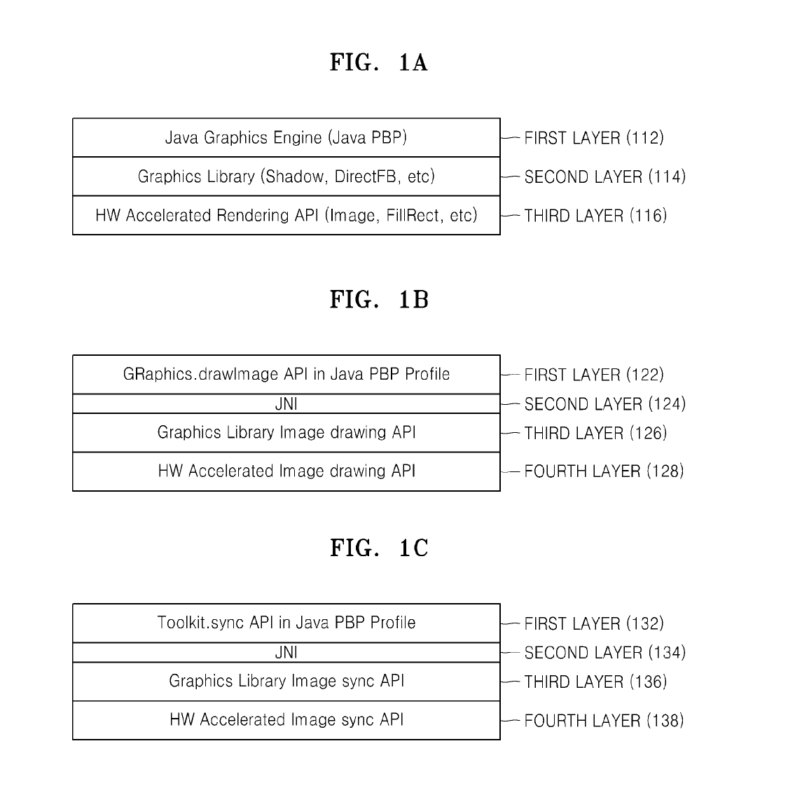

FIGS. 1A, 1B and 1C are layer diagrams of a Java platform, according to an exemplary embodiment.

FIG. 1A is a diagram showing an operation of executing a Java-based rendering application programming interface (API).

Referring to FIG. 1A, it is assumed that the Java platform includes a first layer 112, a second layer 114, and a third layer 116.

In the first layer 112, an API required to process a Java application may be called. At this time, the API may be called from a standard API library of a Java standard.

In the second layer 114, an API may be called from an API library written in a native language. The API called in the second layer 114 corresponds to the API called in the first layer 112. The API called in the first layer 112 and the API called in the second layer 114 perform the same or corresponding functions.

Terminals employing a Java platform may use the same first layer, but may uses different second layers. In particular, the second layer 114 may be written in a programming language such as C or C++, instead of in Java. In this case, an interface such as a Java native interface (JNI) may be required.

In the third layer 116, APIs that are frequently used may be processed by a hardware-based API processing module. The third layer 116 may be omitted, if necessary.

In FIG. 1A, in the first layer 112, an API that performs rendering is called from the standard API library.

Then, in the second layer 114, an API corresponding to the API called from the standard API library is called from a native API library. For example, these APIs perform the same or corresponding functions.

Lastly, in the third layer 116, the API called from the native API library calls an API that performs rendering by a hardware-based module, and thus rendering is performed. At this time, a result from a hardware-based module may be stored in a buffer, output to a display device, or transmitted to an application.

FIG. 1B is a diagram showing an operation of executing a Java-based ‘drawImage’ API, including calling APIs in a first layer 122, a second layer 124, a third layer 126, and a fourth layer 128.

FIG. 1C is a diagram showing an operation of executing a Java-based ‘Toolkit.sync’ API, including calling APIs in a first layer 132, a second layer 134, a third layer 136, and a fourth layer 138. The configuration of each of FIGS. 1B and 1C is the same as the configuration of FIG. 1A except for a JNI in the second layers 124 and 134, and thus detailed descriptions of FIGS. 1B and 1C are omitted. The JNI performs a connection between the standard API library and the native API library.

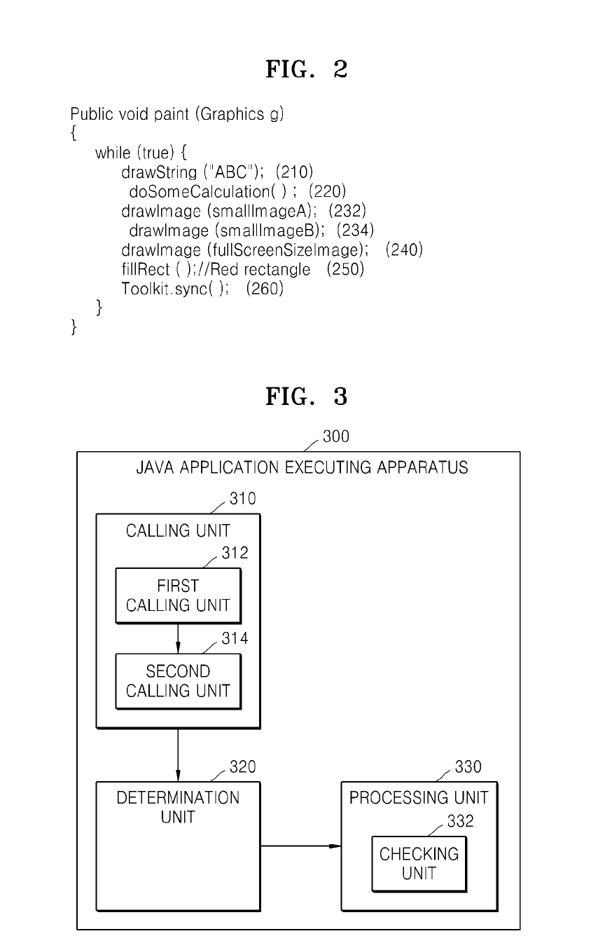

FIG. 2 is a diagram showing an application embodying a GUI, according to an exemplary embodiment.

A ‘drawString’ API 210 is an API for outputting a character, and may be a ‘drawString’ API that is defined in a java.awt.Graphics class.

A ‘doSomeCalculation’ API 220 is a general API for calculating the location and size of a character to be output, and may be referred to as a ‘common Java API’.

The ‘drawImage’ APIs 232, 234, and 240 are APIs for generating predetermined images, and may each be a ‘drawImage’ API that is defined in the java.awt.Graphics class. The ‘drawImage’ APIs 232, 234, and 240 may generate images having various shapes, according to an input value. The ‘drawImage(smallImage)’ APIs 232 and 234 indicate a case where the ‘drawImage’ APIs generate an image having a small size, and the ‘drawImage(fullScreenSizeImage)’ API 240 indicates a case where the ‘drawImage’ API generates an image having a large size.

A ‘fillRect’ API 250 is an API for drawing a rectangular shape, and may be a ‘fillRect’ API defined in the java.awt.Graphics class.

A ‘Toolkit.sync’ API 260 is an API for outputting an image to a display device, and may be a ‘Toolkit.sync’ API defined in the java.awt.Graphics class.

Generally, data regarding processing results of the ‘drawString’ API 210, the ‘drawImage’ APIs 232, 234, and 240, and the ‘fillRect’ API 250 is stored in a storage space such as an internal memory, and then is output on a screen by the ‘Toolkit.sync’ API 260. At this time, the ‘Toolkit.sync’ API 260 copies the data stored in the internal memory into a storage space of the display device, and then generates an image to be output by combining the data. Thus, the ‘Toolkit.sync’ API 260 needs to use the processing results of the ‘drawString’ API 210, the ‘drawImage’ APIs 232, 234, and 240, and the ‘fillRect’ API 250. In this specification, an API using processing results of at least one API that is previously called is referred to as a synchronization API, and an API that does not use a processing result of a previously-called API is referred to as an asynchronization API.

An asynchronization API may be directly processed instead of waiting for a processing result of another API, and thus a processing speed of the asynchronization API is high. An example of the asynchronization API may include a ‘drawImage’ API or a ‘fillRect’ API that is embodied by a hardware-based module.

A synchronization API uses a processing result of another API, and thus the synchronization API may only be processed after other called APIs are processed. An example of the synchronization API may include a ‘Toolkit.sync’ API.

It is assumed that images output on the display device are changed twice. That is, the ‘Toolkit.sync’ API is called twice. For convenience of description, the ‘Toolkit.sync’ API which is called first is referred to as a first synchronization API, and the ‘Toolkit.sync’ API which is called second is referred to as a second synchronization API.

The first synchronization API may be processed after the ‘drawString’ API 210, the ‘drawImage’ APIs 232, 234, and 240, and the ‘fillRect’ API 250 are processed. In particular, since it takes a long time to process the ‘drawImage(fullScreenSizeImage)’ API 240, it takes a long time to process the first synchronization API.

In order to change an image after the first synchronization API is called, the ‘drawImage’ APIs 232, 234, and 240, and the ‘fillRect’ API 250 need to be called again. Theoretically, the ‘drawImage’ APIs 232, 234, and 240, and the ‘fillRect’ API 250 are asynchronization APIs, and thus do not have to wait for processing results of other APIs. However, the ‘drawImage’ APIs 232, 234, and 240, and the ‘fillRect’ API 250 are called again after the first synchronization API is processed. Thus, if processing of the first synchronization API is delayed, since processing of the ‘drawImage’ APIs 232, 234, and 240, and the ‘fillRect’ API 250 is also delayed, the time taken to process an entire application increases.

Thus, effective processing of a synchronization API is one of methods of increasing a processing speed of a Java application.

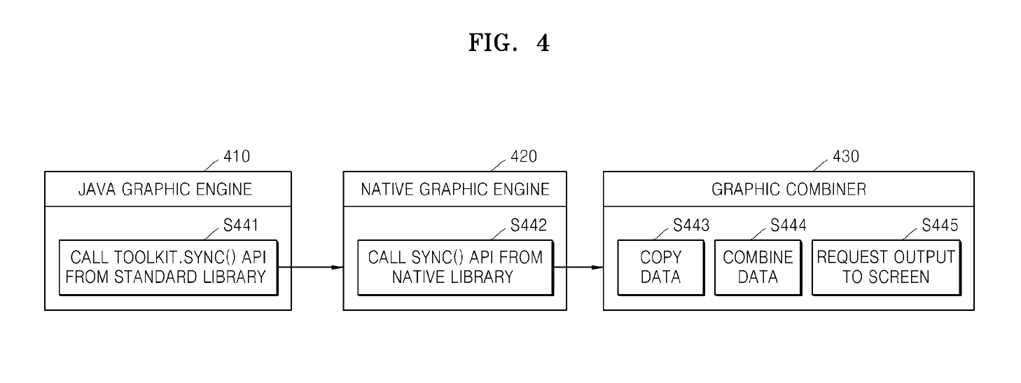

FIG. 3 is a block diagram of a Java application executing apparatus 300 according to an exemplary embodiment.

The Java application executing apparatus 300 includes a calling unit 310, a determination unit 320, and a processing unit 330.

The calling unit 310 calls APIs required to process a Java application. The calling unit 310 may include at least one of a first calling unit 312 which calls an API of a standard API library and a second calling unit 314 which calls an API of a native API library.

The determination unit 320 determines whether each of the called APIs is a synchronization API. As described above, in this specification, a synchronization API refers to an API using processing results of at least one API that is previously called.

When the called APIs are synchronization APIs, the processing unit 330 processes the called APIs through a separate thread. When the called APIs are asynchronization APIs, the processing unit 330 processes the called APIs through an existing (first) thread. A thread refers to a unit for an operation of processing an application. A single application may be processed through a single thread, or alternatively may be processed through a plurality of threads. A processor such as a central processing unit (CPU) assigns physical or logical memory spaces to respective threads, and processes the threads using a time-sharing method. At this time, the more important an operation is, the higher priority a thread has. Thus, the more important an operation is, the earlier an operation is processed.

Hereinafter, operations of elements of the Java application executing apparatus 300 will be described in a time sequence. For convenience of description, a thread calling a synchronization API is referred to as a first thread, and a thread processing the synchronization API is referred to as a second thread. In addition, a synchronization API that is currently called is referred to as a first synchronization API, and a synchronization API that is previously called is referred to as a second synchronization API.

First, the calling unit 310 calls an API required to execute a Java application.

The determination unit 320 determines whether the called API is a synchronization API.

When the called API is a first synchronization API, the processing unit 330 processes the first synchronization API through a second thread. Simultaneously, the processing unit 330 processes asynchronization APIs that are called after the first synchronization API is called, through a first thread.

If necessary, when the first synchronization API is called, a second synchronization API may still be processed through the second thread. That is, when the first synchronization API is called, processing of the second synchronization API may not be completed. In this case, the processing unit 330 may delay processing of the first synchronization API until the second synchronization API is processed.

The processing unit 330 may include a checking unit 332 in order to check whether processing of the second synchronization API is completed when the first synchronization API is called. The checking unit 332 may receive a signal indicating that processing of the second synchronization API is completed from a hardware-based module, from an API called from the Java standard library, or from an API called from the native library.

If processing of the second synchronization API is completed when the first synchronization API is called, the processing unit 330 processes the first synchronization API through the second thread.

In the Java application executing apparatus 300 according to an exemplary embodiment, an executing speed of a Java application is significantly increased by processing the synchronization API through the second thread. Conventionally, in order to process the synchronization API, processing of the synchronization API needs to be delayed until processing of all previous APIs are processed. In addition, until the synchronization API is processed, asynchronization APIs that are to be called after the synchronization API wait without being called. Thus, the time taken to process an application increases. However, in the Java application executing apparatus 300 according to an exemplary embodiment, waiting times of asynchronization APIs may be reduced by processing an asynchronization API and a synchronization API through respective threads.

In addition, when processing of a synchronization API that is previously called is not completed, the number of errors occurring during processing of the synchronization API may be reduced by delaying processing of a synchronization API that is subsequently called.

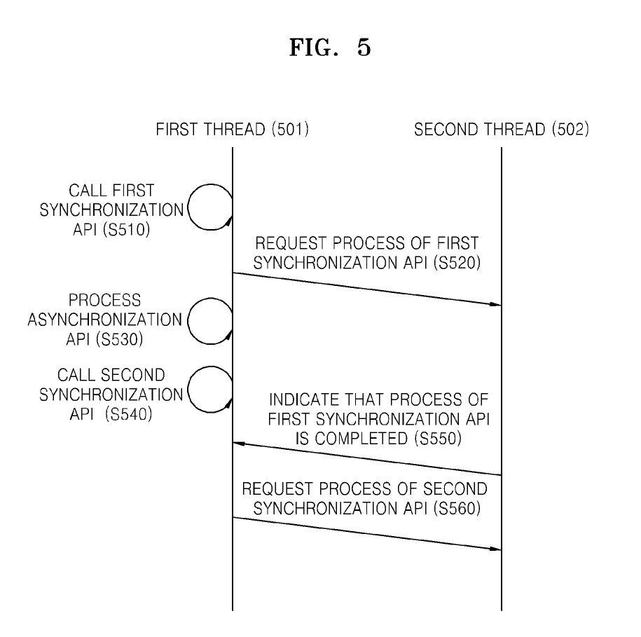

FIG. 4 is a diagram showing a method of executing a Java application in the Java application executing apparatus 300 of FIG. 3, according to an exemplary embodiment.

The Java application executing apparatus 300 may include a Java graphic engine 410 calling an API from a Java standard library, a native graphic engine 420 calling an API from a native API library, and a graphic combiner 430 outputting image data to a display device.

In operation S441, the Java graphic engine 410 calls a ‘Toolkit.sync( )’ API. The ‘Toolkit.sync( )’ API may be used to output a processing result of at least one API on a screen.

In operation S442, the native graphic engine 420 calls an API corresponding to the ‘Toolkit.sync( )’ API from the native API library. That is, the native graphic engine 420 calls a ‘sync( )’ API performing the same function as that of the ‘Toolkit.sync( )’ API from the native API library.

In operation S443, data stored in a buffer is copied into a buffer of a display device. At this time, processing results of at least two APIs may be copied into the buffer of the display device.

In operation S444, the data stored in the buffer of the display device is combined. As an example, when data of characters to be displayed on the screen is generated by processing a single API, and data of pictures to be displayed on the screen is generated by processing another single API, the data of the characters and the data of the pictures are combined and output to the screen, in operation S444.

In operation S445, the combined data is requested to be output.

By performing operations S441 to S445, an image is changed.

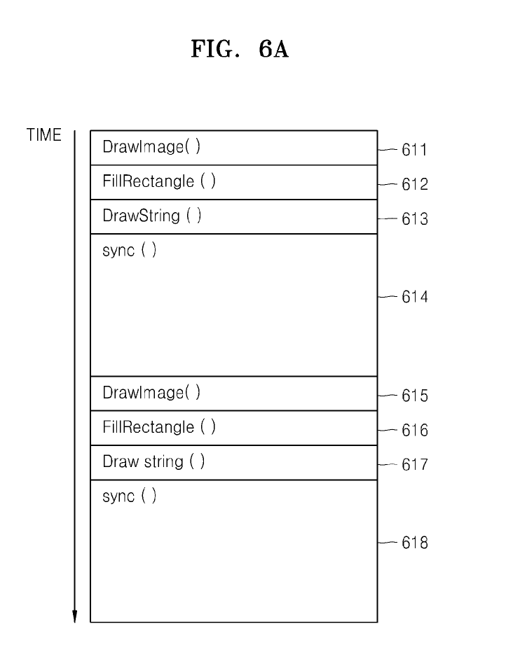

FIG. 5 is a flow chart of a method of executing a Java application, according to an exemplary embodiment of the invention.

Referring to FIG. 5, APIs required to process the Java application are processed through a first thread 501 and a second thread 502. In particular, asynchronization APIs are processed through the first thread 501, and synchronization APIs are processed through the second thread 502.

In operation S510, a first synchronization API is called. For convenience of description, it is assumed that the first synchronization API is a synchronization API that is initially called.

In operation S520, the first thread 501 requests the second thread 502 to process the first synchronization API.

In operation S530, an asynchronization API called after the first synchronization API is processed through the first thread 501. Although not illustrated, simultaneously, the first synchronization API is processed through the second thread 502.

In operation S540, a second synchronization API is called. At this time, the first thread 501 determines whether processing of the first synchronization API is completed. When processing of the first synchronization API is not completed, processing of the second synchronization API is delayed.

In operation S550, a signal indicating that processing of the first synchronization API is completed is received from the second thread 502. At this time, the signal indicating that processing of the first synchronization API is completed may be sent from a hardware-based module, from an API called from the Java standard library, or from an API called from the native library.

In operation S560, the first thread 501 requests the second thread 502 to process the second synchronization API.

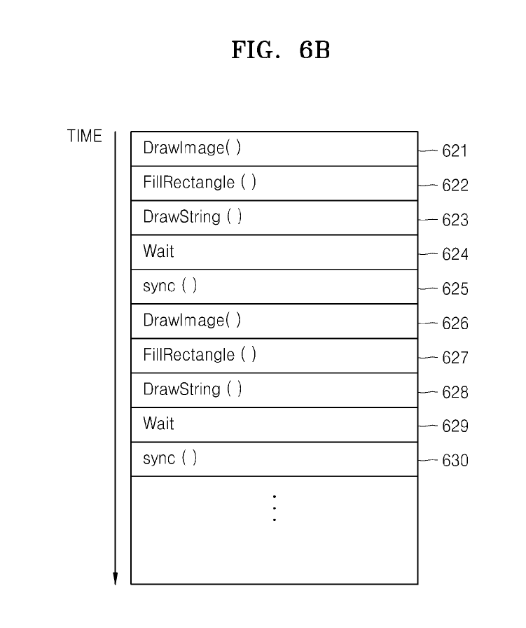

FIGS. 6A and 6B are diagrams showing operations of embodying a GUI using a Java application.

Referring to FIGS. 6A and 6B, executed APIs are illustrated in a time sequence. In addition, the time taken to process a corresponding API is indicated according to the size of a box containing the corresponding API.

FIG. 6A illustrates a case where a GUI is embodied using a conventional method of executing a Java application.

A ‘DrawImage( )’ API 611 draws an image, and then stores resulting data in an internal buffer.

A ‘FillRectangle( )’ API 612 draws a rectangular shape, and then stores resulting data in the internal buffer.

A ‘DrawString( )’ API 613 draws a character, and then stores resulting data in the internal buffer.

A ‘sync( )’ API 614 changes an image using data stored in the internal buffer.

In particular, the ‘sync( )’ API 614 copies the data stored in the internal buffer into an internal space of a display device, and then combines the data. In addition, when the combining of the data is completed, the ‘sync( )’ API 614 performs a predetermined process of outputting the combined data to the display device.

The ‘sync( )’ API 614 is a synchronization API that changes an image using processing results of the ‘DrawImage( )’ API 611, the ‘FillRectangle( )’ API 612, and the ‘DrawString( )’ API 613. Thus, processing of the ‘sync( )’ API 614 needs to be delayed until processing of other APIs are completed. It takes a long time to process the ‘sync( )’ API 614. Thus, processing of asynchronized APIs that are called after the ‘sync( )’ API 614 needs to be delayed.

FIG. 6B illustrates a case where a GUI is embodied using a method of a Java application, according to an exemplary embodiment of the invention.

A ‘DrawImage( )’ API 621 draws an image, and then stores resulting data in an internal buffer.

A ‘FillRectangle( )’ API 622 draws a rectangular shape, and then stores resulting data in the internal buffer.

A ‘DrawString( )’ API 623 draws a character, and then stores resulting data in the internal buffer.

A ‘sync( )’ API 625 is a synchronization API that changes an image using processing results of the ‘DrawImage( )’ API 621, the ‘FillRectangle( )’ API 622, and the ‘DrawString( )’ API 623. Processing of the ‘sync( )’ API 625 needs to be delayed (e.g., during a Wait period 624) in order to process the ‘sync( )’ API 625 after processing of a ‘sync( )’ API that is previously called is completed. When processing of the ‘sync( )’ API that is previously called is completed, the ‘sync( )’ API 625 is processed through another thread.

Since the ‘sync( )’ API 625 is processed through another thread, a ‘DrawImage( )’ API 626, a ‘FillRectangle( )’ API 627, a ‘DrawString( )’ API 628, and the ‘sync( )’ API 624 may be simultaneously processed.

Likewise, processing of a ‘sync( )’ API 630 is delayed (e.g., during a Wait period 629) until processing of the ‘sync( )’ API 625 is completed. When processing of the ‘sync( )’ API 625 is completed, the sync( )API 630 is processed through the second thread.

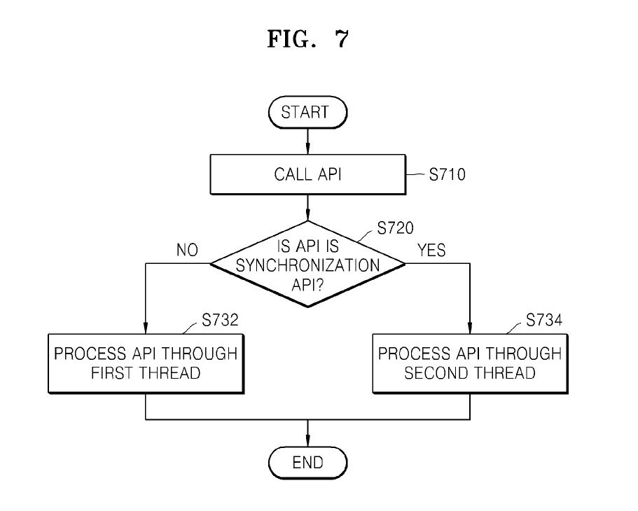

FIG. 7 is a flowchart of a method of executing a Java application, according to another exemplary embodiment.

In operation S710, an API required to process the Java application is called.

In operation S720, it is determined whether the called API is a synchronization API. The synchronization API uses processing results of at least one called API. Hereinafter, for convenience of description, a synchronization API that is currently called is referred to as a first synchronization API, and a synchronization API that is previously called is referred to as a second synchronization API.

As a result of operation S720, when the called API is determined to be a first synchronization API, the first synchronization API is processed through a second thread, in operation S734. At this time, it may be determined whether a process of a second synchronization API is completed, and processing of the first synchronization API may be delayed until processing of the second synchronization API is completed.

In addition, asynchronization APIs that are called after the first synchronization API may be processed through a first thread calling the first synchronization API.

When it is determined in operation S720 that the called API is not a first synchronization API, that is, when the called API is an asynchronization API, the called API is processed through the first thread, in operation S732.

The exemplary embodiments can be written as computer programs stored on a computer readable recording medium and can be implemented in general-use digital computers that execute the programs using the computer readable recording medium.

Examples of the computer readable recording medium include magnetic storage media (e.g., ROM, floppy disks, hard disks, etc.), and storage media such as optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of executing a Java application, the method comprising:
calling, by a first thread, an application programming interface (API) required to execute the Java application;
determining whether the API is a first synchronization API which uses processing results of at least one previously called API; and
if it is determined that the API is the first synchronization API, executing the first synchronization API through a second thread different from the first thread calling the first synchronization API.

2. The method of claim 1, wherein the executing of the first synchronization API comprises:
determining whether processing of a second synchronization API called before the first synchronization API is completed; and
if it is determined that the processing of the second synchronization API is not completed, controlling the first synchronization API to delay the executing of the first synchronization API.

3. The method of claim 1, further comprising processing at least one other API called after the first synchronization API through the first thread.

4. The method of claim 2, wherein the executing of the first synchronization API further comprises, if it is determined that the processing of the second synchronization API is completed, receiving a confirmation signal from the second thread indicating that the processing of the second synchronization API is completed.

5. The method of claim 2, wherein the executing of the first synchronization API further comprises, if it is determined that the processing of the second synchronization API is completed, receiving a confirmation signal, from a hardware-based module, indicating that the processing of the second synchronization API is completed.

6. The method of claim 1, wherein at least one of the first synchronization API and the second synchronization API is an output API which outputs an image to an output device.

7. The method of claim 6, wherein the output API is a ‘sync( )’ API defined in a Java standard library.

8. The method of claim 2, wherein the controlling the first synchronization API to delay the executing of the first synchronization API is performed by the first thread.

9. The method of claim 2, wherein the first synchronization API uses processing results of the second synchronization API.

10. An apparatus for executing a Java application, the apparatus comprising:
a calling unit which includes a first thread which calls an application programming interface (API) required to execute the Java application;
a determination unit which determines whether the API is a first synchronization API which uses processing results of at least one previously called API; and
a processing unit which executes the first synchronization API through a second thread different from the first thread which calls the first synchronization API, if the determination unit determines that the API is the first synchronization API.

11. The apparatus of claim 10, wherein the processing unit comprises:
a completion determining unit which determines whether processing of a second synchronization API called before the first synchronization API is completed; and
a controlling unit which controls the first synchronization API to delay the executing of the first synchronization API, if the completion determining unit determines that the processing of the second synchronization API is not completed.

12. The apparatus of claim 10, wherein the processing unit further processes at least one other API that is called after the first synchronization API through the first thread.

13. The apparatus of claim 11, wherein the completion determining unit comprises a receiving unit which receives a confirmation signal from the second thread indicating that the processing of the second synchronization API is completed.

14. The apparatus of claim 11, wherein the completion determining unit comprises a receiving unit which receives a confirmation signal from a hardware-based module indicating that the processing of the second synchronization API is completed.

15. The apparatus of claim 10, wherein at least one of the first synchronization API and the second synchronization API is an output API which outputs an image to an output device.

16. The apparatus of claim 15, wherein the output API is a ‘sync( )’ API defined in a Java standard library.

17. The apparatus of claim 11, wherein the controlling unit uses the first thread to control the first synchronization API to delay the executing of the first synchronization API.

18. The apparatus of claim 11, wherein the first synchronization API uses processing results of the second synchronization API.

19. A computer readable recording medium having recorded thereon a program for executing the method of claim 1.
